(19) United States
(12) Patent Application Publication
(10) Pub. No.: US 2014/0342715 A1
(43) Pub. Date: Nov. 20, 2014

(54) VIRTUALIZED SUBSCRIBER IDENTIFICATION MODULE (SIM)

(71) Applicant: INTEL CORPORATION, SANTA CLARA, CA (US)

(72) Inventors: Yang Gu, Shanghai (CN); Le Chong Chen, Shanghai (CN); Yong Jiang, Shanghai (CN); Jinkui Ren, Shanghai (CN)

(21) Appl. No.: 13/997,462

(22) PCT Filed: Dec. 28, 2012
(86) PCT No.: PCT/CN2012/087821

§ 371 Date: Jun. 24, 2013

(51) Int. Cl. H04W 8/22; G06F 9/455; H04B 1/38

(52) U.S. Cl. CPC H04W 8/22; H04B 1/3816; G06F 9/455
USPC 455/418; 455/558

(57) ABSTRACT

This disclosure is directed to systems and methods for implementing a virtualized subscriber module (SIM). In general, a device equipped with virtualization resources may be configured to load at least one virtualized SIM. Wireless communication resources in the device may be configured to access the at least one virtualized SIM when, for example, initializing a connection to a wireless network. Some embodiments may include more than one virtualized SIM. For example, a plurality of virtualized SIM may be loaded at the same time (e.g., for use in initializing connections to different wireless networks). In a different embodiment, a determination to be made as to which virtualized SIM to load based on, for example, the detection of available wireless networks. It may also be possible to load a single virtual machine (VM) to emulate various hardware-based SIMs based on, for example, varying information input into the virtual machine.

### TECHNICAL FIELD

The present disclosure relates to wireless communications, and more particularly, to systems for facilitating identification and interaction of subscribers with wireless networks.

### BACKGROUND

As wireless technology develops, the demand for wireless communication continues to grow globally. In addition to large economies that have enjoyed the ability to interact via wireless communication for many years, now emerging industrial areas and less-developed areas are also participating in the wireless boom. Moreover, the variety of wireless-enabled devices that are available on the market also continues to grow. Traditional cellular handsets have now been joined by smartphones, laptop/notebook/netbook computing devices, tablet computers, multimedia streaming devices, etc. As a result, a large multitude of devices may have the ability to interact with a variety of different wireless networks anywhere at any time.

However, a wireless-enabled device is only one part of the wireless communication equation. There also needs to be some form of wireless network with which the device may communicate (e.g., providing access to a WAN such as the Internet). Short-range wireless networks are often free or may be employed on a pay-per-use basis. While able to provide Internet access, these networks are only available in certain areas and may provide dubious security. Long-range wireless networks may be available over a much larger area and may provide a more secure link to the Internet. The devices of user who contract to access long-range wireless networks (e.g., subscribers) may be able to access these networks based on information stored in the device. In one example implementation, subscriber identification module (SIM) cards may insertable into a device to provide identification and other types of information allowing the device to access the network. Most mobile communication devices include only one SIM card slot. If a user changes devices or changes networks (e.g., travels internationally), the SIM card must be replaced in the device. If only on a temporary basis, such as in the instance of international travel, the existing SIM card of the user must be stored until the user returns to their native wireless network. Problems or updates relating to information on the SIM card must be dealt with by mechanical replacement of the SIM card.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example device configured with a virtualized SIM in accordance with at least one embodiment of the present disclosure;

FIG. 2 illustrates an example configuration for a device in accordance with at least one embodiment of the present disclosure;

FIG. 3 illustrates example configurations for virtualized SIMs and related support software in accordance with at least one embodiment of the present disclosure;

FIG. 4 illustrates an example virtualized SIM in accordance with at least one embodiment of the present disclosure; and

FIG. 5 illustrates a flowchart of example operations for a device configured for use with virtualized SIMs in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to systems and methods for implementing a virtualized subscriber module (SIM). In general, a device equipped with virtualization resources may be configured to load at least one virtualized SIM. Wireless communication resources in the device may be configured to access the at least one virtualized SIM when, for example, initializing a connection to a wireless network. Some embodiments may include more than one virtualized SIM. For example, a plurality of virtualized SIM may be loaded at the same time (e.g., for use in initializing connections to different wireless networks). In a different embodiment, a determination to be made as to which virtualized SIM to load based on, for example, the detection of available wireless networks. It may also be possible to load a single virtual machine (VM) to emulate various hardware-based SIMs based on, for example, varying information input into the virtual machine.

In one embodiment, a device may comprise, for example, a communication module to communicate with at least one wireless network and a processing module to at least cause virtualization resources in the device to load at least one virtualized SIM in the device. The communication module may access the virtualized SIM prior to communicating with the at least one wireless network to, for example, obtain device identification information, security information and/or cipher information (e.g., ciphering or deciphering information) required to interact with the wireless network.

It is also possible for the device to include a plurality of virtualized SIMs. In one embodiment, the processor may cause the plurality of virtualized SIMs to be loaded in the device. The communication module may access at least one of the plurality of virtualized SIMs based on the at least one wireless network. In an alternate implementation, the processor may determine a virtualized SIM to load from the plurality of virtualized SIMs available in the device. For example, the communication module may provide information to the processor about available wireless networks for determining the virtualized SIM to load. In one embodiment, the virtualization resources in the device may include a virtual machine manager to load the at least one virtualized SIM in the device, wherein the virtualized SIM may be, for example, a virtual machine configured to emulate a hardware-based SIM card. It may also be possible for the virtual machine is to emulate a plurality of hardware-based SIM cards based on, for example, changing information input into the virtual machine. An example method consistent with at least one embodiment of the present disclosure may comprise causing virtualization resource in the device to load at least virtualized SIM in the device, and initializing communication with at least one wireless network using the at least one virtualized SIM.

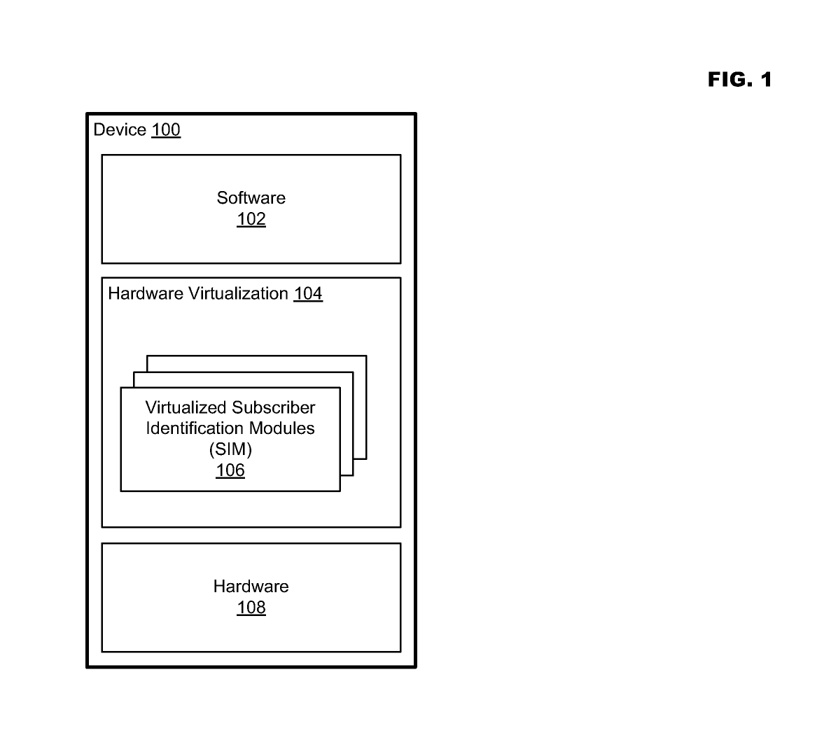

FIG. 1 illustrates an example device configured with a virtualized SIM in accordance with at least one embodiment of the present disclosure. Examples of device 100 may include, but are not limited to, mobile communication devices such as cellular handsets, smartphones, etc. based on the Android® operating system (OS), iOS®, Windows OS®, Blackberry® OS, Palm® OS, Symbian® OS, etc., mobile computing devices such as tablet computers like the iPad®, Surface®, Galaxy Tab®, Kindle Fire®, etc., Ultrabooks® having low-power chipsets manufactured by Intel Corporation, netbooks, notebooks, laptops, etc., typically stationary computing devices such as a desktops, servers, other devices such as set-top boxes, etc.

In general, device 100 may comprise, for example, software section 102, hardware virtualization section 104 including at least one virtualized SIM (VSIM) 106 and hardware section 108. Hardware 108 may include the physical equipment portion of device 100 upon which software 102 may be executed. The execution of software 102 may cause hardware 108 to perform various functions. However, the evolution of computing architecture has yielded a hybrid of hardware and software. Hardware virtualization 108 may include, for example, software that executes in a manner to emulate hardware in device 100. Interactions with actual hardware 108 or virtualized hardware 108 may be transparent to the application, or in other words, applications may interact with virtual hardware just like physical hardware.

Virtualization technology (VT-x) is a feature available in various microprocessors manufactured by the Intel Corporation. VT-x functionality may allow more than one virtual machine (VM) to simultaneously share access to physical processing resources in a safe and efficient manner. For example, VT-x may allow more than one VM to run simultaneously on device 100. Each VM may execute, for example, an occurrence of an operating system (OS).

VT-x virtualization architecture may include multiple processor operational modes. VT-x includes VMX, which supports a special privilege mode called VMX-root that can be utilized for executing a privileged software component known as a “hypervisor” or virtual machine manager (VMM) configured to manage the operation of all VM running on device 100. The VMM may execute as a “host” in device 100, granting the VMM full control of each VM. VMs may run as “guests” in a VMX Non-root mode, which allows the VMs to operate under the supervision of the VMM. In non-root mode, certain instructions and processor events may trigger hardware-assisted transitions to VMX Root mode, allowing the VMM to monitor and control access to key processor resources. While the present disclosure may discuss hardware virtualization in terms of features provided by VT-x, the various embodiments disclosed herein are not limited to implementation using only VT-x. Other hardware (e.g., processors) comprising similar hardware-based security functionality may also be employed in a manner consistent with the various embodiments as disclosed herein.

In the example of FIG. 1, hardware virtualization 104 (e.g., VT-x) may cause at least one VSIM 106 to be loaded into device 100. VSIM 106 may be loaded, for example, when device 100 is activated. At least one advantage that may be realized by loading VSIM 106 when device 100 is activated is that VSIM 106 may be loaded prior to the loading of the OS and other applications wherein potential viruses and/or malware may exist. After VSIM 106 is loaded, the OS and applications on device 100 may access VSIM 106 as they would any hardware in device 100 (e.g., as any hardware-based SIM card), but may be unable to change any programming associated with the operation of VSIM 106.

Once loaded, VSIM 106 may act in a manner similar or identical to a hardware-based SIM card. For example, each VSIM 106 may correspond to a wireless service provider, and the information contained in VSIM 106 may permit device 100 to access the corresponding wireless service provider's network (e.g., to access a WAN like the Internet). A variety of advantages may be realized by using VSIM 106 over an actual physical SIM card. Initially, software-based solutions may perform much better than hardware-based solutions. VSIM 106 may be more resistant to wear and events (e.g., dropping the device) than physical SIM cards because there is no mechanical interface (e.g., a physical SIM may lose connection with a device, fall out of the card slot completely, the slot may become damaged, etc.). Moreover, it is substantially easier, cheaper, etc. to load another VSIM 106 in device 100. Most devices only include a single SIM card slot, requiring the SIM card to be manually switched when the device switches networks (e.g., for international travel). Having to manually switch physical SIM cards introduces a possibility of the physical SIM cards being lost, stolen, damaged, etc.

While including additional SIM card slots in a device may be possible, the investment from a design, expense and space standpoint may be prohibitive. Physical media readers also require significant power to operate, at least when considered from the standpoint of energy limitations of mobile devices. Powering one or more physical media readers is just another unneeded drain on already scarce resources, while VSIM 106 may not cause any increase in power consumption. In terms of functionality, software-based solutions may be, in general, much easier to correct, update, change, etc. than physical media. Adoption may be fast and widespread since the physical changes required to existing designs would be few or none. Standardization may occur across platforms, and thus, secure measures may be devised to initialize devices with a new VSIM 106, change an existing VSIM 106, update an existing VSIM 106, transfer an existing VSIM 106 from one device to another, etc. Consumers may further benefit as some or all of these tasks may be performed remotely as well as locally.

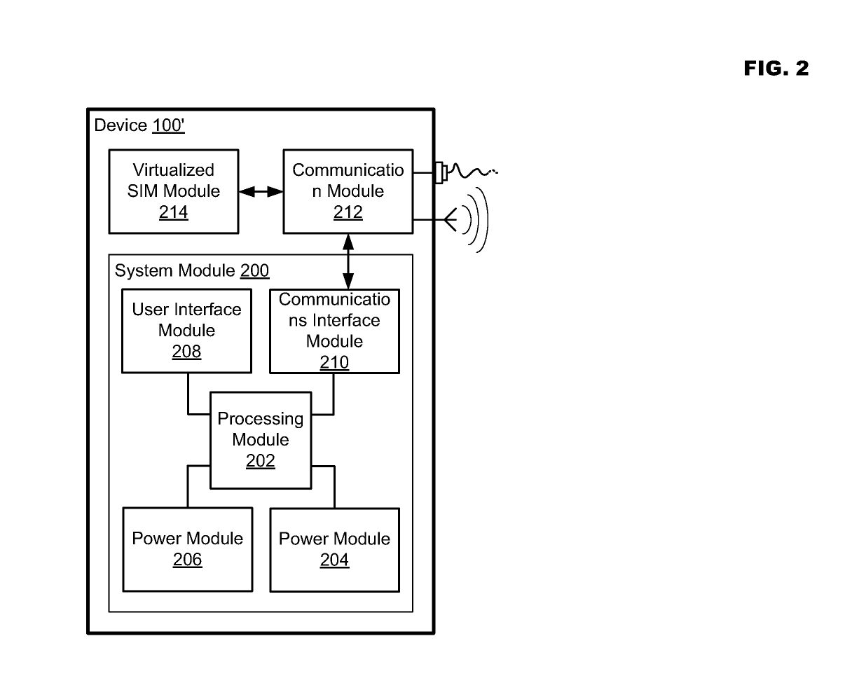

FIG. 2 illustrates an example configuration for device 100′ in accordance with at least one embodiment of the present disclosure. Device 100′ may comprise, for example, system module 200 configured to handle general operations for device 100′. System module 200 may include, for example, processing module 202, memory module 204, power module 206, user interface module 208 and communication interface module 210 (e.g., which may be further coupled to communication module 212). Device 100′ may also comprise VSIM module 214 coupled to at least communication module 214. While communication module 212 and VSIM module 214 have been shown as separate from system module 200, it is also possible in some embodiments for some or all of the features associated with communication module 212 and/or VSIM module 214 to be incorporated in system module 200.

Processing module 200 may comprise one or more processors situated in separate components, or alternatively, may comprise one or more processing cores embodied in one integrated circuit (IC),for example in a System-on-a-Chip (SOC) configuration, and circuitry configured to support the one or more processors. Example processors may include various x86-based microprocessors available from the Intel Corporation including those in the Pentium, Xeon, Itanium, Celeron, Atom, Core i-series product families. Example circuitry configured to support the one or more processors may include interface or bridging circuitry chipsets (e.g., a group of ICs) such as the Northbridge, Southbridge, or subsequently released bridging chipsets from Intel Corporation, that may be configured to handle communications between processing module 202, memory module 204 and other modules communicating on various wired and/or wireless buses in device 100′. For example, bridging circuitry may be configured to handle the signaling between modules by converting from one type/speed of signaling to another, and may be further configured to be compatible with a variety of different devices to allow for different system implementations, upgrades, etc. Some of the functionality described above may also be incorporated within the one or more processors, memory module 204 or other system modules.

Processing module 202 may be configured to execute instructions. Instructions may include program code configured to cause processing module 202 to perform activities such as, but not limited to, reading data, writing data, processing data, formulating data, converting data, transforming data, etc. Information, including instructions, data, etc., may be stored in memory module 204. Memory module 204 may comprise random access memory (RAM) or read-only memory (ROM) in a fixed or removable format. RAM may include memory configured to hold information during the operation of device 100′ such as, for example, static RAM (SRAM) or Dynamic RAM (DRAM). ROM may include memories such as BIOS memory configured to provide instructions when device 100′ activates, programmable memories such as electronic programmable ROMs, (EPROMS), Flash, etc. Other fixed and/or removable memory may include magnetic memories such as floppy disks, hard drives, etc., electronic memories such as solid state flash memory (e.g., eMMC, etc.), removable memory cards or sticks (e.g., USB, uSD, etc.), optical memories such as compact disc-based ROM (CD-ROM), holographic, etc.

Power module 206 may include power sources that are internal to device 100′ (e.g., a battery) and/or external to device 100′ (e.g., electromechanical or solar generator, power grid, fuel cell, etc.) and any related circuitry configured to supply device 100′ with power for operation. User interface module 208 may include circuitry configured to allow users to interact with device 100′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communications interface module 210 may be configured to handle packet routing and other control functions for communication module 212, which may include resources configured to support wired and/or wireless communications. Wired communications may include parallel and serial wired mediums such as, for example, Ethernet, Universal Serial Bus (USB), Firewire, High-Definition Media Interface (HDMI), Digital Visual Interface (DVI), etc. Wireless communications may include, for example, close-proximity wireless mediums (e.g., radio frequency (RF) such as in the instance of RF identification (RFID) or Near-Field Communication (NFC), infrared (IR), optical character recognition (OCR), magnetic readers, etc.), short-range wireless mediums (e.g., Bluetooth, wireless local area networking (WLAN), Wi-Fi, etc.) and long range wireless mediums (e.g., cellular, satellite, etc.). In one embodiment, communications interface module 210 may be configured to prevent wireless communications that are active in communication module 212 from interfering with each other. In performing this function, communications interface module 210 may schedule activities for communication module 212 based on, for example, the relative priority of messages awaiting transmission.

Consistent with the present disclosure, VSIM module 214 may interact with at least communication module 212. VSIM module 214 may include at least one VM configured to operate as VSIM 106 (e.g., to emulate the functionality of one or more hardware-based SIM cards). VSIM 106 may be a VM in that it may emulate features found in its hardware-based equivalent for use by a SIM OS (e.g., a communication-specific OS), a general OS in device 100′ or any software/hardware resource that may need to access a hardware-based SIM card. Typical hardware-based SIM cards may comprise a microcontroller including, for example, a central processing unit (CPU), RAM and ROM memory and an EPROM, an internal bus system for conveying information between the microcontroller and the physical interface to the mobile device (e.g. device 100) and various specialized modules for timing, security, etc. In an example of operation, the ROM and/or EPROM in a hardware-based SIM card may be preprogrammed with information that the CPU may use to compute a temporary value (e.g., stored in RAM). In this manner, an example hardware-based SIM card may use preprogrammed information (e.g., provided by a wireless service provider) to mathematically generate security codes, cypher keys, etc. needed to access a wireless network. VSIM 106 may be a VM that emulates some or all of this functionality using various modules in device 100′ such as processing module 202, memory module 204, etc. For example, communication module 212 may access VSIM 106 in the same manner as accessing a hardware-based SIM card, and in turn, may be accessing a software interface designed to emulate a corresponding hardware interface. Information storage typically handled by the memory resources in the hardware-based SIM card may be handled by memory module 204, and processing typically handled by the microcontroller in a hardware-based SIM card may be handled by processing module 202. Regardless of how tasks are allocated, it may appear to communication module 212 that it is accessing a hardware-based SIM card instead of VSIM 106.

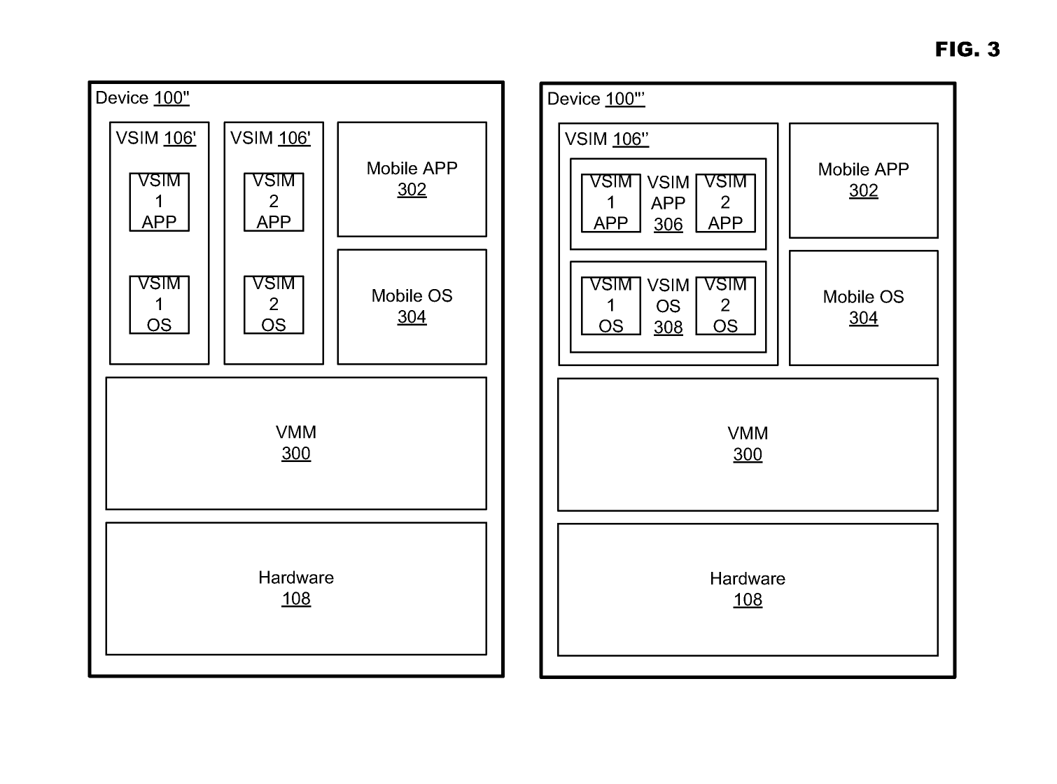

FIG. 3 illustrates example configurations for VSIMs 106 and related support software in accordance with at least one embodiment of the present disclosure. Device 100″ is a first example wherein each VSIM 106′ is a separate VM. In device 100″ VMM 300 may cause a separate VM to load for each VSIM 106′ including, for example, a VSIM application (APP) to emulate the hardware portion of the hardware-based SIM card and a corresponding VSIM OS (e.g., VSIM 1 APP may be associated with VSIM 1 OS, VSIM 2 APP may be associated with VSIM 2 OS, etc.). The associated VSIM OS1, VSIM OS2, etc., may allow VSIM 106′ to emulate hardware-based SIM cards and to interact with, for example, mobile application (APP) 302 and/or mobile OS 304. Device 100′″ illustrates an alternative example wherein VMM 300 may be configured to cause a single VM (e.g., VSIM 106″) to load. VSIM 106″ may include, for example, VSIM Application (APP) 306 to execute instances of VSIM 1 APP, VSIM 2 APP, etc. and VSIM OS 308 to execute corresponding instances of VSIM OS (e.g., SIM 1 OS, SIM 2 OS, etc.). While only VSIM 1 and VSIM 2 are shown, this is merely for the purpose of explanation and is not intended to limit the number of VSIMs to only two.

In one example implementation, VMM 300 may cause a plurality of VSIMs 106 such as VSIM 1, VSIM 2, etc., to be loaded (e.g., at device startup). A separate VM emulating a hardware-based SIM card may be loaded corresponding to each wireless network with which interaction is desired as shown in device 100″, or a plurality of instances corresponding to each VSIM 106 may loaded as shown in device 100′″. For example, the plurality of VSIMs 106 may correspond to wireless networks situated in different regions (e.g., for international travelers), to wireless networks for personal use vs. professional use, etc. Communications module 212 may then determine which VSIM 106 to access based on various criteria. In one embodiment, communication module 212 may sense a particular wireless network within communication range and may then determine to access a particular VSIM 106 based on the wireless network. It may also be possible for communications module 212 to select VSIM 106 based on other criteria such as, for example, geographic location, user configuration, etc.

In another embodiment, the VMM may act selectively to load only one VSIM 106 from a plurality of available VSIMs 106 (e.g., only one VM may be loaded). In determining a VSIM 106 to load, communications module 212 may be able to provide information to VMM 300 about available wireless networks, geographic location, etc., and VMM 300 may choose a VSIM 106 to load from the plurality of available VSIMs 106 based on this information.

Consistent with either of the above example embodiments, VSIM 106 may also be a VM that is at least partially configurable at runtime. Some elements common to all VSIMs 106 may be extracted and provided as, for example a software development kit (SDK) for development and runtime execution. Each VSIM 106 may then retain its own information and programming that may override default programming in the VM. More than one VSIM 106 may still be loaded at the same time. Altering the configuration of VSIM 106 at runtime would, to some degree, sacrifice the security of loading preconfigured and unalterable VSIMs 106 during activation, but would also provide an easier way for wireless service providers to update, change, correct VSIM 106.

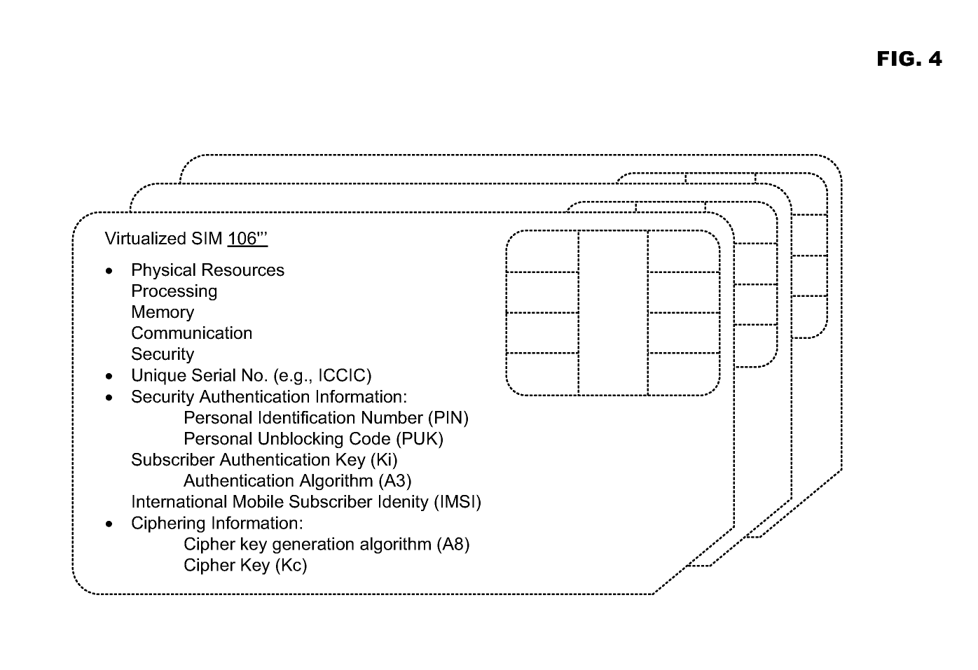

FIG. 4 illustrates example VSIM 106′″ in accordance with at least one embodiment of the present disclosure. In addition to emulating physical resources such as the processing, memory, communication and security resources described above in regard to FIG. 3, example VSIM 106′″ may comprise preprogrammed information (or may mathematically generate temporary information) needed for communications module 212 to access at least one wireless network. For example, VSIM 106′″ may comprise and/or generate device identification information, security information and cipher information (e.g., codes and/or data needed for ciphering information going out to the at least one wireless network or deciphering information coming in from the at least one wireless network). An example of a device identifier code may include a unique serial number such as an integrated circuit card identifier code (ICCIC). Examples of security information may include, but are not limited to, a personal identification number (PIN), a personal unblocking code (PUK), a subscriber authentication key (Ki), an authentication algorithm, (A3), an international mobile subscriber identity (IMSI), etc. Examples of cipher information may include, but are not limited to, a cipher key generation algorithm (A8), a cipher key (Kc), etc. While FIG. 4 shows a variety of information that may be stored on, or generated by, VSIM 106′″, the types of information that may be stored on VSIM 106′″ are not limited only to the disclosed examples. Any type of information that may aid a device attempting to access a wireless network be stored on VSIM 106′″.

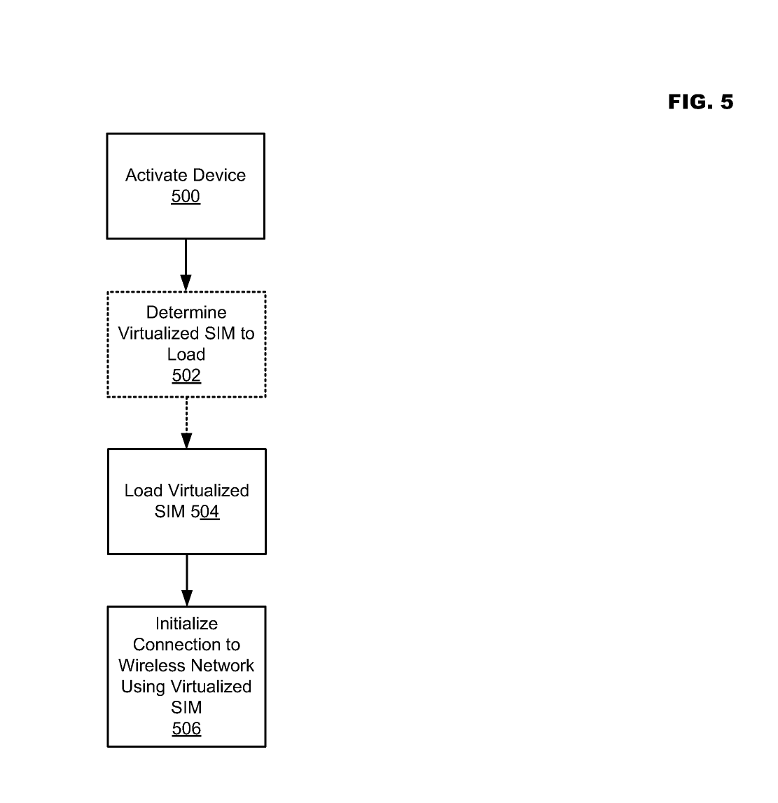

FIG. 5 illustrates a flowchart of example operations for a device configured for use with virtualized SIMs in accordance with at least one embodiment of the present disclosure. In operation 500 a device may be activated. Device activation may be followed by optional operation 502 wherein a VSIM to load from a plurality of VSIMs available in the device may be determined. Operation 502 may be optional in that there may be only one VSIM in the device (and thus no determination would be needed) or, in some implementations, all VSIMs available in the device may be loaded. In operation 504 at least one VSIM may be loaded in the device. For example, a VMM in the device may cause the VSIM to be loaded. Following loading of the at least one VSIM in operation 504, in operation 506 the device may initialize connection to a wireless network using the at least one VSIM (e.g., a communication module may access the at least one VSIM to get information needed to access the wireless network).

While FIG. 5 illustrates various operations according to an embodiment, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to systems and methods for implementing a virtualized subscriber module (SIM). In general, a device equipped with virtualization resources may be configured to load at least one virtualized SIM. Wireless communication resources in the device may be configured to access the at least one virtualized SIM when, for example, initializing a connection to a wireless network. Some embodiments may include more than one virtualized SIM. For example, a plurality of virtualized SIM may be loaded at the same time (e.g., for use in initializing connections to different wireless networks). In a different embodiment, a determination to be made as to which virtualized SIM to load based on, for example, the detection of available wireless networks. It may also be possible to load a single virtual machine (VM) to emulate various hardware-based SIMs based on, for example, varying information input into the virtual machine.

The following examples pertain to further embodiments. In one example there is provided a device. The device may include a communication module to communicate with at least one wireless network, and a processor to cause virtualization resources in the device to load at least one virtualized subscriber identity module (SIM) in the device.

The above example device may be further configured, wherein the communication module is also to access the at least one virtualized SIM prior to communicating with the at least one wireless network. In this configuration the example device may be further configured, wherein the at least one virtualized SIM is to provide at least one of device identification information, security information or cipher information for use in communicating with the at least one wireless network.

The above example device may be further configured, alone or in combination with the above further configurations, wherein the processor is to cause a plurality of virtualized SIMs to be loaded in the device. In this configuration the example device may be further configured, wherein the communication module is also to access at least one of the plurality of virtualized SIMs based on the at least one wireless network.

The above example device may be further configured, alone or in combination with the above further configurations, wherein the processor is further to determine a virtualized SIM to load from a plurality of virtualized SIMs available in the device. In this configuration the example device may be further configured, wherein the communication module is further to provide information about available wireless networks to the processor for determining the virtualized SIM to load.

The above example device may be further configured, alone or in combination with the above further configurations, wherein the virtualization resources include a virtual machine manager to load the at least one virtualized SIM in the device. In this configuration, the example device may be further configured, wherein the virtualized SIM is a virtual machine configured to emulate a hardware-based SIM card. In this configuration the example device may be further configured wherein the virtual machine is to emulate a plurality of hardware-based SIM cards based on changing information input into the virtual machine.

In another example there is provided a method. The method may comprise causing virtualization resources in the device to load at least one virtualized subscriber identity module (SIM) in the device, and initializing communication with at least one wireless network using the at least one virtualized SIM.

The above example method may be further configured, wherein a plurality of virtualized SIMs are loaded in the device. In this configuration the method may be further comprise determining at least one virtualized SIM from the plurality of virtualized SIMs to use in initializing the communication.

The above example method may further comprise, alone or in combination with the above further configurations, determining a virtualized SIM to load in the device from a plurality of virtualized SIMs available in the device based on information about available wireless networks provided by a communication module in the device.

The above example method may further comprise, alone or in combination with the above further configurations, obtaining at least one of device identification information, security information or cipher information from the at least one virtualized SIM for use in initializing the communication.

In another example there is provided at least one machine-readable storage medium having stored thereon, individually or in combination, instructions that when executed by one or more processors result in the following operations comprising causing virtualization resources in the device to load at least one virtualized subscriber identity module (SIM) in the device, and initializing communication with at least one wireless network using the at least one virtualized SIM.

The above example medium may be further configured, wherein a plurality of virtualized SIMs are loaded in the device. In this configuration the example medium may further comprise instructions that when executed by one or more processors result in the following operations comprising determining at least one virtualized SIM from the plurality of virtualized SIMs to use in initializing the communication.

The above example medium may further comprise, alone or in combination with the above further configurations, instructions that when executed by one or more processors result in the following operations comprising determining a virtualized SIM to load in the device from a plurality of virtualized SIMs available in the device based on information about available wireless networks provided by a communication module in the device.

The above example medium may further comprise, alone or in combination with the above further configurations, instructions that when executed by one or more processors result in the following operations comprising obtaining at least one of device identification information, security information or cipher information from the at least one virtualized SIM for use in initializing the communication.

In another example there is provided a device. The device may include a communication module to communicate with at least one wireless network, and a processing module to at least cause virtualization resources in the device to load at least one virtualized subscriber identity module (SIM) in the device.

The above example device may be further configured, wherein the communication module is also to access the at least one virtualized SIM prior to communicating with the at least one wireless network, the at least one virtualized SIM to provide at least one of device identification information, security information or cipher information for use in communicating with the at least one wireless network. In this configuration the example device may be further configured, wherein the processing module is to cause a plurality of virtualized SIMs to be loaded in the device, the communication module is also to access at least one of the plurality of virtualized SIMs based on the at least one wireless network.

The above example device may be further configured, alone or in combination with the above further configurations, wherein the processing module is further to determine a virtualized SIM to load from a plurality of virtualized SIMs available in the device. In this configuration the example device may be further configured, wherein the communication module is also to provide information about available wireless networks to the processing module for determining the virtualized SIM to load.

The above example device may be further configured, alone or in combination with the above further configurations, wherein the virtualization resources include a virtual machine manager to load the at least one virtualized SIM in the device, the virtualized SIM being a virtual machine to emulate a hardware-based SIM card. In this configuration the example device may be further configured, wherein the virtual machine is to emulate a plurality of hardware-based SIM cards based on changing information input into the virtual machine.

In another example there is provided a method. The method may include causing virtualization resources in the device to load at least one virtualized subscriber identity module (SIM), and initializing communication with at least one wireless network using the at least one virtualized SIM.

The above example method may be further configured, wherein a plurality of virtualized SIMs are loaded in the device. In this configuration the example method may further comprise determining at least one virtualized SIM from the plurality of virtualized SIMs to use in initializing the communication.

The above example method may further comprise, alone or in combination with the above further configurations, determining a virtualized SIM to load in the device from a plurality of virtualized SIMs available in the device based on information about available wireless networks provided by a communication module in the device.

The above example method may further comprise, alone or in combination with the above further configurations, obtaining at least one of device identification information, security information or cipher information from the at least one virtualized SIM for use in initializing the communication.

In another example there is provided a system comprising at least a device including wireless communication and hardware virtualization resources, the system being arranged to perform any of the above methods.

In another example there is provided a chipset arranged to perform any of the above example methods.

In another example there is provided at least one machine readable medium comprising a plurality of instructions that, in response to be being executed on a computing device, cause the computing device to carry out any of the above example methods.

In another example there is provided a device. The device may include a communication module to communicate with at least one wireless network, and a processor to cause virtualization resources in the device to load at least one virtualized subscriber identity module (SIM) in the device.

The above example device may be further configured, wherein the communication module is also to access the at least one virtualized SIM prior to communicating with the at least one wireless network. In this configuration the example device may be further configured, wherein the at least one virtualized SIM is to provide at least one of device identification information, security information or cipher information for use in communicating with the at least one wireless network.

The above example device may be further configured, alone or in combination with the above further configurations, wherein the processor is to cause a plurality of virtualized SIMs to be loaded in the device. In this configuration the example device may be further configured, wherein the communication module is also to access at least one of the plurality of virtualized SIMs based on the at least one wireless network.

The above example device may be further configured, alone or in combination with the above further configurations, wherein the processor is further to determine a virtualized SIM to load from a plurality of virtualized SIMs available in the device. In this configuration the example device may be further configured, wherein the communication module is further to provide information about available wireless networks to the processor for determining the virtualized SIM to load.

The above example device may be further configured, alone or in combination with the above further configurations, wherein the virtualization resources include a virtual machine manager to load the at least one virtualized SIM in the device. In this configuration, the example device may be further configured, wherein the virtualized SIM is a virtual machine configured to emulate a hardware-based SIM card. In this configuration the example device may be further configured wherein the virtual machine is to emulate a plurality of hardware-based SIM cards based on changing information input into the virtual machine.

In another example there is provided a method. The method may comprise causing virtualization resources in the device to load at least one virtualized subscriber identity module (SIM) in the device, and initializing communication with at least one wireless network using the at least one virtualized SIM.

The above example method may be further configured, wherein a plurality of virtualized SIMs are loaded in the device. In this configuration the method may be further comprise determining at least one virtualized SIM from the plurality of virtualized SIMs to use in initializing the communication.

The above example method may further comprise, alone or in combination with the above further configurations, determining a virtualized SIM to load in the device from a plurality of virtualized SIMs available in the device based on information about available wireless networks provided by a communication module in the device.

The above example method may further comprise, alone or in combination with the above further configurations, obtaining at least one of device identification information, security information or cipher information from the at least one virtualized SIM for use in initializing the communication.

In another example there is provided a system. The system may include means for causing virtualization resources in the device to load at least one virtualized subscriber identity module (SIM), and means for initializing communication with at least one wireless network using the at least one virtualized SIM.

The above example system may be further configured, wherein a plurality of virtualized SIMs are loaded in the device. In this configuration, the example system may further comprise means for determining at least one virtualized SIM from the plurality of virtualized SIMs to use in initializing the communication.

The above example system may further comprise, alone or in combination with the above further configurations, means for determining a virtualized SIM to load in the device from a plurality of virtualized SIMs available in the device based on information about available wireless networks provided by a communication module in the device.

The above example system may further comprise, alone or in combination with the above further configurations, means for obtaining at least one of device identification information, security information or cipher information from the at least one virtualized SIM for use in initializing the communication.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-20. (canceled)

21. A device, comprising:
a communication module to communicate with at least one wireless network; and
a processing module to at least cause virtualization resources in the device to load at least one virtualized subscriber identity module (SIM) in the device space.

22. The device of claim 21, wherein the communication module is also to access the at least one virtualized SIM prior to communicating with the at least one wireless network.

23. The device of claim 22, wherein the at least one virtualized SIM is to provide at least one of device identification information, security information or cipher information for use in communicating with the at least one wireless network.

24. The device of claim 21, wherein the processing module is to cause a plurality of virtualized SIMs to be loaded in the device.

25. The device of claim 24, wherein the communication module is also to access at least one of the plurality of virtualized SIMs based on the at least one wireless network.

26. The device of claim 21, wherein the processing module is further to determine a virtualized SIM to load from a plurality of virtualized SIMs available in the device.

27. The device of claim 26, wherein the communication module is also to provide information about available wireless networks to the processing module for determining the virtualized SIM to load.

28. The device of claim 21, wherein the virtualization resources include a virtual machine manager to load the at least one virtualized SIM in the device.

29. The device of claim 28, wherein the virtualized SIM is a virtual machine configured to emulate a hardware-based SIM card.

30. The device of claim 29, wherein the virtual machine is to emulate a plurality of hardware-based SIM cards based on changing information input into the virtual machine.

31. A method, comprising:
causing virtualization resources in the device to load at least one virtualized subscriber identity module (SIM); and
initializing communication with at least one wireless network using the at least one virtualized SIM.

32. The method of claim 31, wherein a plurality of virtualized SIMs are loaded in the device.

33. The method of claim 32, further comprising determining at least one virtualized SIM from the plurality of virtualized SIMs to use in initializing the communication.

34. The method of claim 31, further comprising determining a virtualized SIM to load in the device from a plurality of virtualized SIMs available in the device based on information about available wireless networks provided by a communication module in the device.

35. The method of claim 31, further comprising obtaining at least one of device identification information, security information or cipher information from the at least one virtualized SIM for use in initializing the communication.

36. At least one machine-readable storage medium having stored thereon, individually or in combination, instructions that when executed by one or more processing modules result in the following operations comprising:
causing virtualization resources in the device to load at least one virtualized subscriber identity module (SIM); and
initializing communication with at least one wireless network using the at least one virtualized SIM.

37. The medium of claim 36, wherein a plurality of virtualized SIMs are loaded in the device.

38. The medium of claim 37, further comprising instructions that when executed by one or more processing modules result in the following operations comprising:
determining at least one virtualized SIM from the plurality of virtualized SIMs to use in initializing the communication.

39. The medium of claim 36, further comprising instructions that when executed by one or more processing modules result in the following operations comprising:
determining a virtualized SIM to load in the device from a plurality of virtualized SIMs available in the device based on information about available wireless networks provided by a communication module in the device.

40. The medium of claim 36, further comprising instructions that when executed by one or more processing modules result in the following operations comprising: obtaining at least one of device identification information, security information or cipher information from the at least one virtualized SIM for use in initializing the communication.
